(19) United States
(12) Patent Application Publication
(10) Pub. No.: US 2024/0330774 A1
(43) Pub. Date: Oct. 3, 2024

(54) METHOD OF SEARCHING FOR AN OPTIMAL COMBINATION OF HYPERPARAMETERS FOR A MACHINE LEARNING MODEL

(71) Applicant: STMicroelectronics International N.V., Geneva (CH)

(72) Inventors: He Huang, Paris (FR); Basile Wolfrom, La Garde (FR)

(21) Appl. No.: 18/623,615

(22) Filed: Apr. 1, 2024

(30) Foreign Application Priority Data
Apr. 3, 2023 (FR) 2303291

(51) Int. Cl. G06N 20/00

(52) U.S. Cl. CPC G06N 20/00

(57) ABSTRACT

A computer-implemented method can be used for searching for an optimal hyperparameter combination for defining a machine learning model. The method includes performing tests of hyperparameter combinations. Each test of hyperparameter combination includes a training phase and a test phase. The training phase is adapted to train the machine learning model from training data and the test phase is adapted to calculate a performance score associated with the hyperparameter combination tested from test data. The optimal hyperparameter combination corresponds to the hyperparameter combination having obtained the best performance score among the hyperparameter combinations tested. A weighting coefficient is used for adjusting an amount of training data used for the training phase. The weighting coefficient is dynamically adapted during different tests of the hyperparameter combinations.

### CROSS-REFERENCE TO RELATED APPLICATIONS

This application claims the benefit of French Patent Application No. 2303291, filed on Apr. 3, 2023, which application is hereby incorporated herein by reference.

### TECHNICAL FIELD

Embodiments relate to a method of searching for an optimal combination of hyperparameters for a machine learning model.

### BACKGROUND

Machine learning is a branch of artificial intelligence that enables a computing system to learn from data, without having been explicitly programmed to perform a given task.

Machine learning enables a machine to acquire knowledge and skills from a set of data, in order to make predictions, classifications or other types of processing operations on new data.

A machine learning model is a mathematical representation of a system or process that enables a machine to learn from data.

The model is created using a machine learning algorithm that learns from a set of training data to produce a predicted output for a given input.

The choice of model depends on the type of problem to be solved and on characteristics of the data available. There are different types of machine learning model. For example, linear models, decision trees and artificial neural networks are known.

Machine learning uses hyperparameters defined for training a model. Hyperparameters are parameters defined before the model is trained.

Hyperparameters can comprise, for example, a learning rate (a factor determining the size of the model weight update intervals during training), a number of iterations (the number of times the model runs through the data set during training), a model structure (the number of layers for a neural network and the number of neurons per layer, for example).

Hyperparameters can have a significant impact on model performance. It is therefore appropriate to search for, that is optimize, hyperparameters that will improve or even optimize results of the model.

Hyperparameter optimization is a method in which several hyperparameter combinations are evaluated on a set of validation data.

Different methods of searching for hyperparameter combinations exist. These methods include gate search, random search and Bayesian search, for example.

Hyperparameter combinations are evaluated by performing a phase of training the machine learning model and then a test phase.

The training phase is adapted to train the machine learning model on a set of training data. The test phase is adapted to calculate a performance score associated with the hyperparameter combination tested from a set of test data.

The set of training data and the set of test data are provided by a user. These data are representative of the target application for the machine learning model.

The amount of training data has an impact on the duration of the training phase. The more training data, the longer the training phase. As a result, the search for an optimal hyperparameter combination can take a relatively long time when the amount of training data is large.

Furthermore, some of the hyperparameter combinations searched for can be complex. These complex hyperparameter combinations imply a longer training phase.

On the other hand, some complex hyperparameter combinations are of low performance. Nevertheless, even if a combination is of low performance, it is necessary to carry out a training phase in order to determine performance of these complex hyperparameter combinations.

Evaluating some complex hyperparameter combinations is therefore time-consuming if their calculated performance proves insufficient.

There is therefore a need to provide a solution for reducing the time taken to search for the optimum hyperparameter combination, especially when the amount of training data provided by a user is large.

### SUMMARY

Implementation modes and embodiments relate to machine learning, in particular embodiments to the optimization of hyperparameters of a machine learning model.

According to one aspect, a computer-implemented method can be for searching for an optimal hyperparameter combination making it possible to define an automatic learning model. The method comprises several tests of hyperparameter combination, each test of hyperparameter combination including a training phase and a test phase. The training phase is adapted to train the machine learning model from training data and the test phase being adapted to calculate a performance score associated with the hyperparameter combination tested from test data. The optimum hyperparameter combination corresponds to the hyperparameter combination having obtained the best performance score of the hyperparameter combinations tested. The method further comprises defining a weighting coefficient for adjusting the amount of training data used for the training phase. The weighting coefficient is dynamically adapted during the different tests of the hyperparameter combinations.

In such a method, the training phase of the tests of hyperparameter combination is carried out with training data whose amount is dynamically adjusted.

The amount of training data for a training phase is dynamically adjusted to use only a reduced number of training data for some tests of hyperparameter combination so as to accelerate the method for searching for an optimum hyperparameter combination.

Indeed, it is not necessary to train the machine learning model with all the training data in order to measure an approximation of the performance of a hyperparameter combination.

In particular, a portion of the training data is generally sufficient to measure an approximation of the performance of a hyperparameter combination. For example, a portion corresponding to 10% of the training data is sufficient to obtain an approximation of the performance of a hyperparameter combination.

Using only a portion of the training data enables the training phase to be carried out more quickly. The training phase of the tests of hyperparameter combinations is the most time-consuming step of the search method.

As a result, reducing the execution time of the training phases also makes it possible to carry out the hyperparameter combination search method more quickly for a given number of hyperparameter combinations to be tested, or to increase the number of hyperparameter combinations to be tested for a given period of execution of the hyperparameter combination search method.

Using all the test data provided by the user to evaluate performance of the hyperparameter combination ensures that all the hyperparameter combinations tested are evaluated in the same way.

Once the optimal hyperparameter combination has been found, the optimal model can be trained with the set of training data, in order to obtain the best performance from this machine learning model. Thus, the quality of the optimal model is guaranteed.

Advantageously, the weighting coefficient is initialized to an initial weighting coefficient.

Preferably, the initial weighting coefficient is less than or equal to 1.

Advantageously, the weighting coefficient is updated for each test of hyperparameter combination.

In one advantageous implementation mode, updating the weighting coefficient to be used for a given test of hyperparameter combination comprises calculating a new weighting coefficient from an old weighting coefficient used during the test of hyperparameter combination directly preceding the given test of hyperparameter combination.

Preferably, the new weighting coefficient is calculated by the formula k*α, where α is the old weighting coefficient and k is a coefficient greater than 1, for example between 1 and 2.

Such a calculation of the new weighting coefficient makes it possible to gradually increase the quantity of training data taken into account during the training phase. This makes it possible to favor relatively small weighting coefficients while also retaining some higher coefficients. In particular, such an update of the weighting coefficient makes it possible to exponentially increase the quantity of training data.

Alternatively, it is possible to calculate the new weighting coefficient by adding a given value to the old weighting coefficient. For example, it is possible to add a value of 1% to the old weighting coefficient to obtain the new weighting coefficient.

In one advantageous implementation mode, the method further comprises defining a dynamically defined best weighting coefficient, this best weighting coefficient corresponding to the weighting coefficient used for the training phase of the test of the hyperparameter combination having obtained the best performance score among the hyperparameter combinations already tested.

Preferably, updating the weighting coefficient comprises comparing the new weighting coefficient with the value 100% and with the value w*A, where A is the best defined weighting coefficient and w is a coefficient greater than 1, for example between 2 and 8, especially equal to 4, the weighting coefficient being updated to the value of the new weighting coefficient if the new weighting coefficient calculated is less than or equal to the value 100% or to the value w*A, or updated to the value of the initial weighting coefficient otherwise.

Such an update of the weighting coefficient prevents the weighting coefficient from being too high at the start of the search for an optimal hyperparameter combination. Such an update of the weighting coefficient also makes it possible to test higher weighting coefficients than the best weighting coefficient, as the new weighting coefficient cannot be greater than w*A. Such an update of the weighting coefficient allows the weighting coefficient to be gradually increased.

In an advantageous embodiment, the method further comprises training a machine learning model defined by said optimal combination of hyperparameters with all the training data.

Alternatively, or in combination, the method further comprises, for each machine learning model defined by a combination of hyperparameters having made it possible to obtain a better performance score among the combinations of hyperparameters already tested, a training of this model with the full training data each time a better performance score is obtained.

According to another aspect, there is provided a computer program product comprising instructions which, when the program is executed by a computer, cause the same to implement a method as described above.

According to another aspect, there is provided a computing system comprises a memory in which a computer program as previously described is stored and a processing unit configured to implement the computer program.

### BRIEF DESCRIPTION OF THE DRAWINGS

Further advantages and characteristics of the invention will become apparent upon examining the detailed description of embodiments, which are by no means limiting, and of the appended drawings in which:

FIG. 1 illustrates a computing system SYS configured to implement a method according to embodiments; and

FIG. 2 illustrates an embodiment method.

### DETAILED DESCRIPTION OF ILLUSTRATIVE EMBODIMENTS

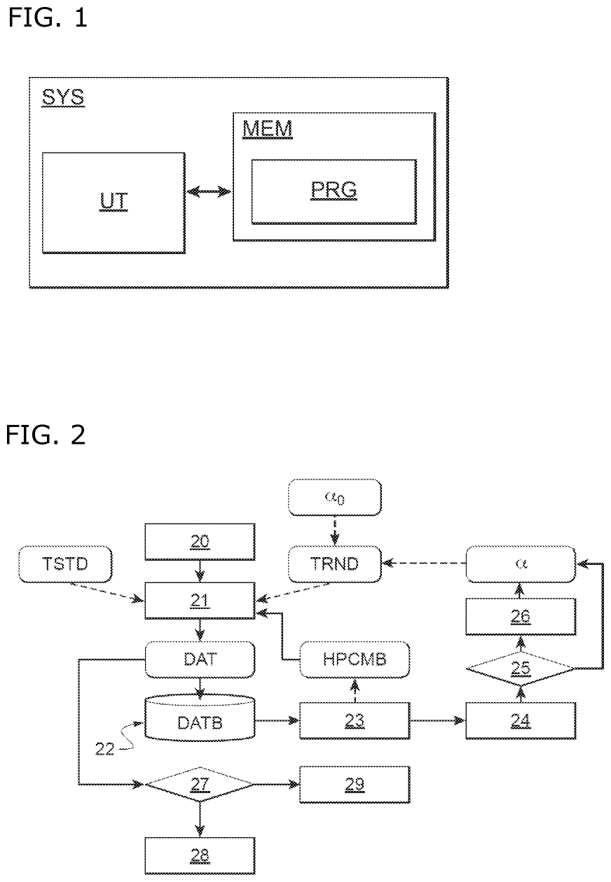

FIG. 1 illustrates a computing system SYS configured to implement a method for searching for an optimal hyperparameter combination as described below in connection with FIG. 2.

The computing system SYS comprises a processing unit UT and a memory MEM.

The processing unit UT can be implemented with one or more processors. The memory MEM can be a non-volatile memory.

The memory MEM is configured to store a computer program PRG. This computer program PRG comprises instructions which, when executed by the processing unit UT, cause the same to implement the method as described below.

The computing system SYS may, for example, be a server or a personal computer.

FIG. 2 illustrates a method for searching for an optimal hyperparameter combination for an automatic learning model. Such a method can be implemented by a computing system SYS as previously described above.

The machine learning model is chosen according to a user-defined application. The model may be a linear model, a decision tree or an artificial neural network, as examples.

It is important to note that these models are not exhaustive and that there are many other machine learning models used to solve different types of problems relating to the application defined by the user.

The machine learning model is associated with a hyperparameter combination. In order to obtain a machine learning model with good performance, it is appropriate to search for an optimal hyperparameter combination for this machine learning model.

In particular, each hyperparameter combination searched for is tested to measure a performance of that hyperparameter combination.

The optimal hyperparameter combination corresponds to the hyperparameter combination obtaining a best performance score among a set of searched hyperparameter combinations.

More particularly, the method comprises an initialization step 20. In this initialization step, a first hyperparameter combination is randomly generated.

In this initialization step 20, a best score is initialized to a predefined value, for example 0.

As will be described later, during the method for searching for an optimal hyperparameter combination, the best score is updated as soon as a performance score of a test of hyperparameter combination is higher than the previous best score defined. The best score is then updated by this performance score.

The method then comprises an evaluation step 21. As is described below, this evaluation step 21 is performed for each hyperparameter combination searched for. In this evaluation step 21, a performance of the hyperparameter combination to be tested is evaluated.

For example, the performance of a hyperparameter combination can be evaluated using a cross-validation method well known to the skilled person.

The cross-validation can be chosen from the “Leave p out cross-validation,” “Leave one out cross-validation,” “Holdout cross-validation,” “Repeated random subsampling validation,” “k-fold cross-validation,” “Stratified k-fold cross-validation,” “Time Series cross-validation” and “Nested cross-validation” types.

More particularly, evaluating the performance of a hyperparameter combination comprises a machine learning model training phase and a machine learning model test phase.

The machine learning model training phase uses training data TRND. The training data are provided by the user.

More particularly, the amount of training data TRND used for the training phase depends on a weighting coefficient α less than or equal to 100%.

The weighting coefficient α makes it possible to select a portion of the training data provided by the user. The ratio of a size of this portion of the training data to a size of all the training data corresponds to the weighting coefficient α.

The training data in the portion may be selected randomly.

The weighting coefficient α is initialized to an initial weighting coefficient α0 entered by the user. Preferably, the initial weighting coefficient α0 is close to 0%. For example, the initial weighting coefficient α0 can be initialized to 1%.

In this way, the amount of training data used to evaluate the first hyperparameter combination is relatively small.

The weighting coefficient α then changes during the method for searching for the optimum hyperparameter combination until it approaches 100% at the end of the search for the optimum hyperparameter combination.

It is also possible to impose a minimum amount of training data to be used for the training phase. In particular, when the trained model is a classification model, it is possible to provide, for each class defined, a minimum number of samples representative of this class, for example 50 samples.

The test phase of the machine learning model uses a set of test data TSTD supplied by the user to evaluate performance of the hyperparameter combination.

The amount of test data used in the evaluations of the different hyperparameter combinations searched for is always the same.

Preferably, the test phase of each evaluation step uses all the test data TSTD provided by the user to evaluate performance of the hyperparameter combination. This ensures that all tested hyperparameter combinations are evaluated in the same way.

The evaluation step makes it possible to calculate a performance score associated with the hyperparameter combination. The performance score calculated, the hyperparameter combination tested and the weighting coefficient α form a data set DAT output from the evaluation step 21.

The performance score calculated, the hyperparameter combination tested and the weighting coefficient α used are stored during a step 22 in a part DATB of the memory MEM of the computing system SYS.

The method then comprises a step 23 of searching for a new hyperparameter combination. In this step, a new hyperparameter combination is searched for.

The new hyperparameter combination is searched for using a search algorithm that is well known to the person skilled in the art.

For example, the search algorithm can be chosen from a gate search, a random search or a Bayesian search.

The search for a new hyperparameter combination makes it possible to obtain a new hyperparameter combination HPCMB which will subsequently be tested by repeating the method from evaluation step 21.

The method also includes a step 24 of calculating a new weighting coefficient. This new weighting coefficient will be used for the next iteration of the evaluation step 21 if its value meets conditions defined in the verification step 25 described below.

In particular, the new weighting coefficient α is calculated from the old weighting coefficient α. For example, the new weighting coefficient α corresponds to the value k*α, where a is the old weighting coefficient and k is a user-defined coefficient greater than 1, for example between 1 and 2.

Such a calculation of the new weighting coefficient makes it possible to gradually increase the quantity of training data taken into account during the training phase. This makes it possible to favor relatively small weighting coefficients while also retaining some higher coefficients.

Alternatively, it is possible to calculate the new weighting coefficient by adding a given value to the old weighting coefficient. For example, it is possible to add a value of 1% to the old weighting coefficient to obtain the new weighting coefficient.

The method then includes a verification step 25. In this step 25, the new weighting coefficient is compared with two thresholds. In particular, the new weighting coefficient α is compared with 100% and with a value w*A, where A corresponds to a best weighting coefficient, and w is a user-defined coefficient greater than 1. The coefficient w is for example between 2 and 8, especially equal to 4.

The best weighting coefficient A corresponds to the weighting coefficient α used to evaluate the hyperparameter combination that gave the last best score among the hyperparameter combinations already tested.

If the new weighting coefficient α is greater than 100% or the value w*A, then the new weighting coefficient is modified in a step 26 to be equal to the initial weighting coefficient.

If the new weighting coefficient α is less than or equal to 100% or the value w*A, then the new weighting coefficient is maintained.

The new weighting factor α is then used for the next iteration of evaluation step 21.

Following each evaluation step 21, the method also includes a performance score comparison step 27. In this step 27, the performance score calculated in evaluation step 21 is compared with a best performance score.

If the performance score calculated in evaluation step 21 is higher than the best score, then the method includes a step 28 of updating the best score. In this step 28, the best score is updated by the performance score calculated during the evaluation step.

If the performance score calculated is greater than the best score, then the method also comprises a step 29 of updating the best weighting coefficient A. In this step 29, the best weighting coefficient A is updated by the weighting coefficient α used for the evaluation of the hyperparameter combination having obtained the performance score greater than the best score.

This best weighting coefficient A is initialized to the value of the initial weighting coefficient do.

As indicated previously, for each new hyperparameter combination searched for, the method is repeated from evaluation step 21 to evaluate the new hyperparameter combination.

Nevertheless, the training phase of each evaluation step 21 is carried out using training data, the amount of which depends on the weighting coefficient α which is increased at each iteration of the evaluation step until it reaches 100% or the value w*A.

This makes it possible to increase the amount of training data taken into account during the training phase of the evaluation step during the different iterations of the evaluation step 21, until the weighting coefficient reaches 100% or the value w*A.

In particular, such a method makes it possible to gradually increase the quantity of training data taken into account during the training phase. In addition, such a method uses a dynamic ceiling fixed by the value w*A. In this way, the exponential increase in the weighting coefficient does not reach 100% at each iteration, in particular at the start of the process. More specifically, the ceiling w*A increases overall during the process. However, the value of A can decrease locally. In this case, the ceiling also decreases locally. Thus, the increase in the w*A ceiling is not exponential, but is linked to the weighting coefficient which made it possible to obtain a new best performance score.

In such a method, the training phase of the hyperparameter combination evaluation steps is performed with training data whose amount is dynamically adjusted.

The amount of training data for a training phase is dynamically adjusted to use only a reduced number of training data for some tests of hyperparameter combination so as to accelerate the method for searching for an optimum hyperparameter combination.

Indeed, it is not necessary to train the machine learning model with all of the training data in order to measure an approximation of the performance of a hyperparameter combination.

In particular, a portion of the training data is generally sufficient to measure an approximation of the performance of a hyperparameter combination. For example, a portion corresponding to 10% of the training data is sufficient to obtain an approximation of the performance of a hyperparameter combination.

Using only a portion of the training data allows the training phase of the evaluation step to be carried out more quickly. The training phase of the hyperparameter combination evaluation steps corresponds to the step of the search method that takes the longest to complete.

As a result, reducing the execution time of the training phases also makes it possible to carry out the hyperparameter combination search method more quickly for a given number of hyperparameter combinations to be tested, or to increase the number of hyperparameter combinations to be tested for a given period of execution of the hyperparameter combination search method.

Once the optimal hyperparameter combination has been found, the optimal model can be trained with all the training data, so as to obtain the best performance from this machine learning model. Thus, the quality of this optimal model is guaranteed.

Alternatively, or in combination, it is also possible to train the model with the entire training data each time a new best score is obtained. This training can be carried out in parallel with the iterations of steps 21 to 29. Such training makes it possible to guarantee the quality of each model trained with all of the training data. In addition, it is possible for the user to stop the iterations of steps 21 to 29 as soon as he considers that a trained model is sufficiently efficient.

What is claimed is:

1. A computer-implemented method for searching for an optimal hyperparameter combination for defining a machine learning model, the method comprising:
performing a plurality of tests of hyperparameter combination, each test of hyperparameter combination including a training phase and a test phase, wherein the training phase is adapted to train the machine learning model from training data and the test phase is adapted to calculate a performance score associated with the hyperparameter combination tested from test data, the optimal hyperparameter combination corresponding to the hyperparameter combination having obtained the best performance score among the hyperparameter combinations tested; and
defining a weighting coefficient for adjusting an amount of training data used for the training phase, the weighting coefficient being dynamically adapted during different tests of the hyperparameter combinations.

2. The method according to claim 1, wherein the weighting coefficient is initialized to an initial weighting coefficient.

3. The method according to claim 2, wherein the initial weighting coefficient is less than or equal to 1%.

4. The method according to claim 1, wherein the weighting coefficient is updated for each test of hyperparameter combination.

5. The method according to claim 4, wherein updating the weighting coefficient to be used for a given test of hyperparameter combination comprises calculating a new weighting coefficient from an old weighting coefficient used during the test of hyperparameter combination directly preceding the given test of hyperparameter combination.

6. The method according to claim 5, wherein the new weighting coefficient is calculated by a formula k*α, where α is the old weighting coefficient and k is a coefficient greater than 1.

7. The method according to claim 1, further comprising defining a dynamically defined best weighting coefficient, this best weighting coefficient corresponding to the weighting coefficient used for the training phase of the test of the hyperparameter combination having obtained the best performance score among the hyperparameter combinations already tested.

8. The method according to claim 7, wherein updating the weighting coefficient comprises comparing a new weighting coefficient with the value 100% and with the value w*A, where A is the best weighting coefficient defined and w is a coefficient greater than 1, the weighting coefficient being updated to the value of the new weighting coefficient if the new weighting coefficient calculated is less than or equal to the value 100% or to the value w*A, or updated to the value of an initial weighting coefficient otherwise.

9. The method according to claim 1, further comprising training a machine learning model defined by the optimal combination of hyperparameter with all the training data.

10. The method according to claim 1, further comprising, for each machine learning model defined by a combination of hyperparameters having made it possible to obtain a better performance score among the combinations of hyperparameters already tested, training of this model with all the data each time a better performance score is obtained.

11. A non-transitory memory storing a computer program comprising instructions which, when the program is executed by a computer, cause the computer to implement a method comprising:
performing a plurality of tests of hyperparameter combination, each test of hyperparameter combination including a training phase and a test phase, wherein the training phase is adapted to train a machine learning model from training data and the test phase is adapted to calculate a performance score associated with the hyperparameter combination tested from test data; and
defining a weighting coefficient for adjusting the amount of training data used for the training phase, the weighting coefficient being dynamically adapted during different tests of the hyperparameter combinations to determine an optimal hyperparameter combination corresponding to the hyperparameter combination having obtained the best performance score among the hyperparameter combinations tested.

12. A computing system comprising:
the memory according to claim 11; and
a processing unit coupled to the memory and configured to execute the computer program.

13. The computing system according to claim 12, wherein the weighting coefficient is initialized to an initial weighting coefficient.

14. The computing system according to claim 13, wherein the initial weighting coefficient is less than or equal to 1%.

15. The computing system according to claim 12, wherein the weighting coefficient is updated for each test of hyperparameter combination.

16. The computing system according to claim 15, wherein updating the weighting coefficient to be used for a given test of hyperparameter combination comprises calculating a new weighting coefficient from an old weighting coefficient used during the test of hyperparameter combination directly preceding the given test of hyperparameter combination.

17. The computing system according to claim 16, wherein the new weighting coefficient is calculated by a formula k*α, where α is the old weighting coefficient and k is a coefficient greater than 1.

18. A computer-implemented method for searching for an optimal hyperparameter combination for defining an automatic learning model, the method comprising:
initializing a weighting coefficient;
receiving training data;
receiving test data;
evaluating a performance of a hyperparameter combination, the evaluating being performed in a training phase using a portion of the training data based on the weighting coefficient and a test phase using the test data;
calculating a performance score associated with the hyperparameter combination;
calculating a new weighting coefficient that is greater than the initial weighting coefficient;
repeating the evaluating for a new hyperparameter combination, the repeated evaluating performed with a portion of the training data based on the new weighting coefficient and the test data;
calculating a new performance score associated with the hyperparameter combination; and
comparing the performance score with the new performance score.

19. The method according to claim 18, wherein the steps of calculating a new weighting coefficient, evaluating a new hyperparameter combination and, calculating a new performance score are repeated until an optimal hyperparameter combination is obtained, the optimal hyperparameter combination corresponding to the hyperparameter combination having obtained the best performance score among the hyperparameter combinations evaluated.

20. The method according to claim 18, wherein the initial weighting coefficient is less than or equal to 1%.
